(19) United States
(12) Patent Application Publication
(10) Pub. No.: US 2008/0034438 A1
(43) Pub. Date: Feb. 7, 2008

(54) MULTIPLE HIERARCHY ACCESS CONTROL METHOD

(75) Inventor: Kwabena Mireku, Durham, NC (US)

Correspondence Address: CANTOR COLBURN LLP - IBM RSW, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/462,840

(22) Filed: Aug. 7, 2006

(51) Int. Cl. H04L 9/32; H04N 7/16; G06F 17/30; H04L 9/00; G06F 7/04; G06K 9/00; H03M 1/68; H04K 1/00

(52) U.S. Cl. 726/27; 726/28; 726/29; 726/30; 713/165; 713/167

(57) ABSTRACT

A method for controlling access of a principal to a plurality of resources is disclosed. The method includes organizing each of the plurality of resources such that they are capable of classification by a set of hierarchies. Access permissions are assigned to each role of a set of roles, each role capable of being associated with the principal. Assigning a role of the set of roles to the principal, and associating the role assignment with at least one first resource of the plurality of resources within the first hierarchical structure. The method continues with retrieving the role assigned to the principal, retrieving one or more access permissions for the role, dynamically creating a request permission in response to an attempted action by the principal, comparing the request permission to the access permission, and, in response to determining that the access permission allows the request permission, granting access.

### TRADEMARKS

IBM ® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to data access control, and particularly to security mechanisms for controlling data access.

2. Description of Background

Before our invention, access control systems generally protected hierarchical resources by placing permissions at various locations within the resource hierarchy. According to these methods, a user is granted access to a resource if they have the appropriate permission at that location in the resource hierarchy. However, this provides only one hierarchy of resource protection.

### SUMMARY OF THE INVENTION

The shortcomings of the prior art are overcome and additional advantages are provided through the provision of a method for combining multiple classification hierarchies with the resource hierarchy to make an access decision. In an embodiment, this is achieved by storing the classification hierarchies within a permission, associating the permission with a role, and mapping a user to the role within the resource hierarchy.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which will utilize multiple, distinct classification hierarchies to secure resources contained within a resource hierarchy.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a processing unit in accordance with an embodiment of the invention.

FIG. 2 illustrates one example of a resource hierarchical structure in accordance with an embodiment of the invention.

FIG. 3 illustrates one example of an object classification hierarchical structure in accordance with an embodiment of the invention.

FIG. 4 illustrates one example of an attribute classification hierarchical structure in accordance with an embodiment of the invention.

FIG. 5 illustrates one example of a flow chart depicting a security configuration phase of a method to define data access in accordance with an embodiment of the invention.

FIG. 6 illustrates one example of a flow chart depicting a security enforcement phase of a method to define data access in accordance with an embodiment of the invention.

The detailed description explains the preferred embodiments of the invention, together with advantages and features, by way of example with reference to the drawings.

### DETAILED DESCRIPTION OF THE INVENTION

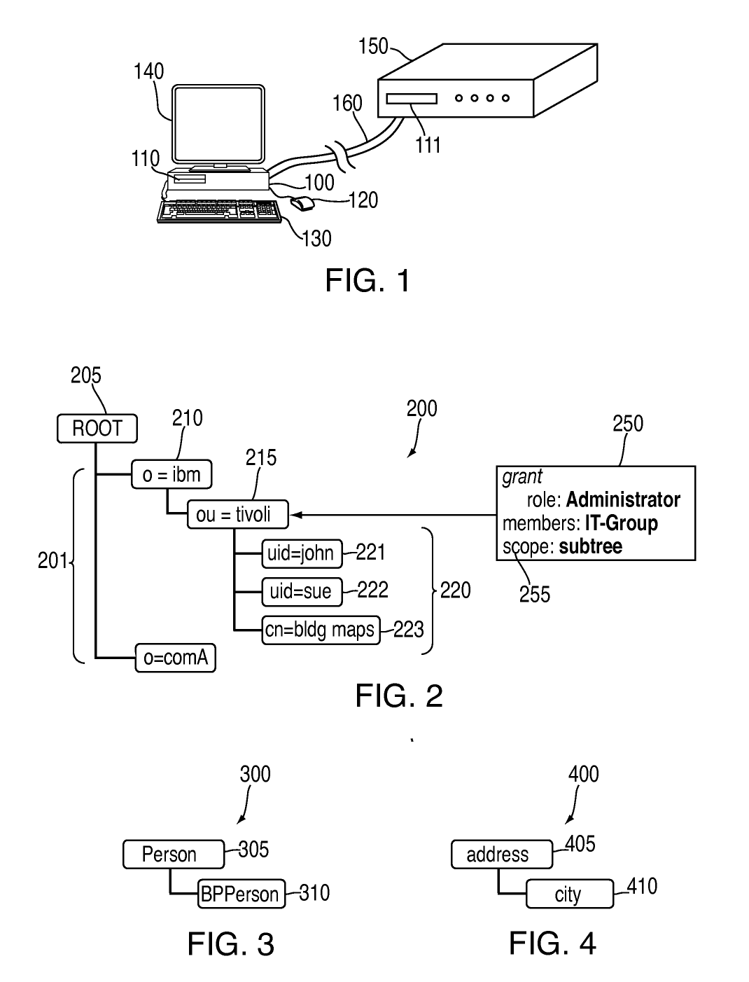

Turning now to the drawings in greater detail, it will be seen that FIG. 1 depicts an embodiment of an exemplary processing unit 100 in data communication with a data storage device 110. The processing unit 100 may be in data communication with input devices, such as a mouse 120 and a keyboard 130, for example, and an output device, such as a display screen 140. An additional data storage device 111 may be located within a server 150 in signal communication with the processing unit 100 via a network 160 or wireless communication. Either storage device 110, 111 may contain data, also herein referred to as resources.

While an embodiment has been depicted with a server connected to processing unit, and data stored upon a data storage device at either the processing unit or the server, it will be appreciated that the scope of the invention is not so limited, and that the invention will also apply to alternate arrangements of processing units and servers, such as having many processing units in data communication with one server, many processing devices in data communication with many servers, and many processing devices in connection with many servers, which are also connected to other servers, for example. While an embodiment has been depicted with a processing unit in data communication with a server via a wired network, it will be appreciated that the scope of the invention is not so limited, and that the invention will also apply to other methods of data communication, such as wireless connection networks, for example.

Referring now to FIG. 2, an exemplary embodiment of an organizational resource hierarchical structure 200 is depicted. In an embodiment, the first hierarchical structure 200 is a structure that is used to define the manner in which a plurality of resources 201 may be stored, or organized, within the data storage device 110, 111. Alternatively, the first hierarchical structure 200 may be known as a directory, or file structure.

The first hierarchical structure 200 will comprise a root resource 205 from which the plurality of resources 201 will be subordinate. In the example shown, it will be appreciated that a o=ibm resource 210 is subordinate to the root resource 205. In similar fashion, a ou=tivoli resource 215 will be subordinate to the o=ibm resource 210. Stated alternatively, it will be appreciated that the o=ibm resource 210 contains the ou=tivoli resource 215. Similarly, it will be appreciated that the ou=tivoli resource 215 also contains additional resources 220. These resources are stored within the first hierarchical structure 200 according to some logical scheme. For example, in the first hierarchical structure 200 shown in FIG. 2, it will be appreciated that a uid=john resource 221 and a uid=sue resource 222 will represent, and contain, various data relating to persons associated with the ou=tivoli resource 215 within the o=ibm resource 210. Similarly, it will be appreciated that a cn=bldg maps resource 223 will represent, and contain, data relating to maps of a building of the tivoli organization of the IBM company.

Referring now to FIG. 3, an exemplary embodiment of a classification hierarchy structure 300 is depicted. The classification hierarchy structure 300 depicted in FIG. 3 may be referred to as an object structure, as it is related to the classification of the object, or the type, of the resource 220 to which it is associated. In the embodiment depicted in FIG. 3, it may be seen that a Business Partner (BP) Person resource 310 is a subordinate subset of a Person resource 305. Referring back to FIG. 2, it will be appreciated that there is no relation between the organization of first hierarchical structure 200 and the object hierarchical structure 300. However, if it is supposed that each resource 220 includes data that relates to the classification hierarchy structure 300, hierarchies 200 and 300 may be used together to secure the resources 220. It will be further appreciated that the cn=bldg maps resource 223 shown in FIG. 2 as subordinate to the ou=tivoli resource 215 may have no relation to the classification hierarchy structure 300 shown in FIG. 3.

Referring now to FIG. 4, another exemplary embodiment of a classification hierarchy structure 400 is depicted. The classification hierarchy structure 400 depicted in FIG. 4 may be referred to as an attribute structure, as it is related to the classification of the contents within the resource 220 to which it is associated. In the embodiment depicted in FIG. 4, it may be seen that a city resource 410 is a subordinate subset of an address resource 405. Referring back to FIG. 2, it will be appreciated that there is no relation between the organization of first hierarchical structure 200 and the object attribute structure 400. However, if it is supposed that each resource 220 includes data that relates to an address 405 and a component of that address contains the city resource 410, hierarchies 200 and 400 may be used together to secure the resources 220. It will be further appreciated that the although the cn=bldg maps resource 223 may not have had any relation with the classification hierarchy structure 300, that it may, along with the uid=john resource 221 and the uid=sue resource 222, be related to the classification hierarchy structure 400 shown in FIG. 4.

While an embodiment of the invention has been depicted describing a Person/BP-Person object classification hierarchy and an Address/City attribute classification hierarchy, it will be appreciated that the scope of the invention is not so limited, and that additional object and attribute classification hierarchies that relate to the resources 220 contained within the first hierarchical structure 200 may exist and be utilized. Further, while an embodiment of the invention has been described having classification resource hierarchies comprising an object and an attribute resource hierarchy, it will be appreciated that the scope of the invention is not so limited, and that additional classification hierarchies, related to the resources 220 contained within the first hierarchical structure 200, may exist and be utilized.

In an embodiment of the invention, multiple, distinct classification hierarchies 300, 400 unrelated to each other and the first hierarchical structure 200 are used to secure the resources 220.

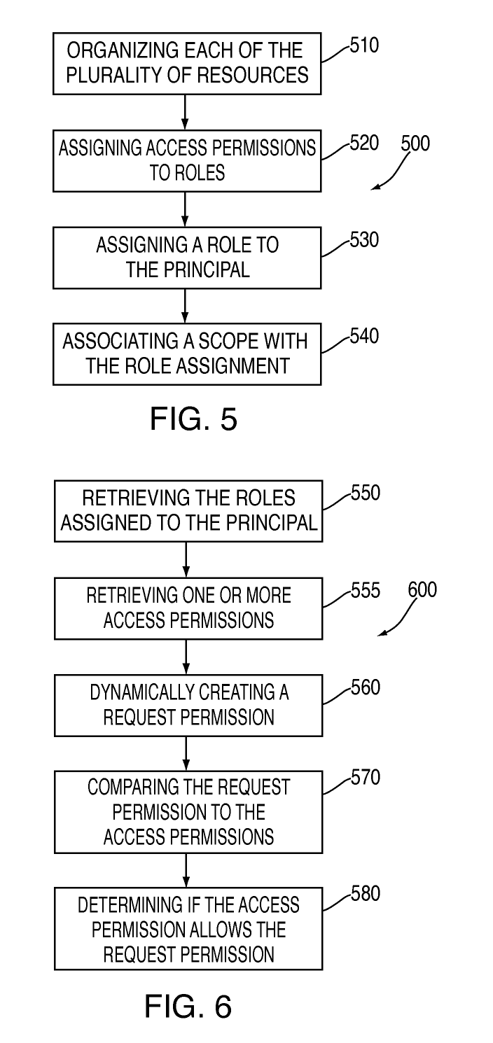

Referring now to FIG. 5, a flow chart 500 of a method for controlling access of a user (also herein referred to as a principal) to the plurality of resources 201, is depicted. Specifically, the flow chart 500 depicts a security configuration phase, to define which data each principal is allowed to access. The method begins with organizing 510 each of the plurality of resources 201 within the first hierarchical structure 200 such that they are suitable for administering access policies, and capable of classification by the set of additional hierarchies 300, 400 unrelated to the first hierarchical structure 200, thereby providing for the use of multiple hierarchies 300, 400 for controlling access of the principal to the resources 201 contained within the first hierarchical structure 200, for example. In an embodiment, the organizing 510 each of the plurality of resources 201 within a first hierarchical structure 200 comprises organizing 510 each of the plurality of resources 201 within the first hierarchical structure 200 in accordance with an organization's business and geographical structure, as depicted in FIG. 2 for the company IBM in 200.

The method includes assigning 520 access permissions to each role of a set of roles, each role capable of being associated with the principal. An exemplary embodiment may comprise roles such as User, Operator, and Administrator, for example, with each role having varying access to perform an action, such as the capability to read, change, add, or remove data within differing resources 201 of the first hierarchical structure 200.

In an embodiment, the assigning 520 access permissions is via one or more of the classification hierarchies 300, 400, and an action that the principal may be allowed to perform relative to the resources 201, such as one or more of the ability to read, change, add, and delete data within the resources 201. In an embodiment, the classification hierarchies 300, 400 are associated with contents of the resources 201 and are capable of including subordinate classification hierarchies 310, 410 via wildcard operators, such as an asterisk, for example. For example an access assignment of the form UserPermission(“Person/*”,“address/*”,“READ”) will allow the principal to read any portion of resources 201 associated with the person object 305, and the address attribute 405, and any subordinate portions thereof.

The method continues with assigning 530 a role of the set of roles to the principal, and associating the role assignment with at least one first resource of the plurality of resources 201 within the first hierarchical structure 200. Referring back to FIG. 2, it will be appreciated from the example depicted that the association of the role is graphically depicted via a grant box 250. It will be further appreciated that any principal that is a member of the IT-Group will be granted the role of Administrator at the first resource of ou=tivoli 215. Next, associating 540 a scope 255 with the role assignment, the scope 255 defining a relationship between the at least one first resource 215 and other resources 201 within the first hierarchical structure 200. It will be appreciated from the graphical grant box 250 depicted in FIG. 2 that the scope of the assignment of Administrator to members of the IT-Group shall be applied to any subordinate resources 220, as indicated by the term “subtree”.

While an embodiment of the invention has been described having a scope of “subtree”, it will be appreciated that the scope of the invention is not so limited, and that the invention will also apply to embodiments using other scopes, such as “all” or “current”, to reflect all possible resources 201, or only the first resource (the ou=tivoli resource 215 in the example of FIG. 2) to which the role assignment has been granted via the grant box 250.

While an embodiment of the invention has been depicted with a single role assignment via the grant box 250, it will be appreciated that the scope of the invention is not so limited, and that the invention will also apply to first resource hierarchy structures 200 that may have multiple grant boxes 250 to assign the access rights of different roles at multiple resources 201. This completes the security configuration phase.

Referring now to FIG. 6, a flow chart 600 of an embodiment of a method for controlling access of a user (also herein referred to as a principal) to the plurality of resources 201, is depicted. Specifically, the flow chart 600 depicts a security enforcement phase, to determine whether a particular principal is allowed to access some particular data, based on the security configuration phase. During security enforcement, the method proceeds by first retrieving 550 the role a principal is granted, or assigned, based on the hierarchical location of the resource the principal is accessing.

While an embodiment of the invention has been described assigning and retrieving one role with respect to the principal, it will be appreciated that the scope of the invention is not so limited, and that the invention will also apply to the assignment and retrieval of more than one role with respect to the principal.

The method next proceeds by retrieving 555 one or more access permissions for the roles that the principal is granted. The access permissions will define precisely what actions, upon which data of the resources 201, the principal will be allowed to perform, as defined by the multiple classification hierarchies 300, 400 that are distinct from the first hierarchical structure 200. In an embodiment, multiple access permissions can be associated with a role.

In response to an attempted action by the principal upon a second resource, such as one of the resources 220, the method continues by dynamically creating 560 a request permission, defined by the at least two (in this embodiment) of the classification hierarchies 300, 400 and the action that the principal has attempted to perform, comparing 570 the request permission to the access permissions, and in response to determining 580 that the access permissions allows the request permission, granting access to the principal to perform the attempted action. In an embodiment, the comparing 570 comprises a wildcard string comparison on the at least two classification hierarchies 300, 400 and an exact string comparison on the action.

In an embodiment, the method further comprises determining the role of the principal at a given resource within the first hierarchical structure 200 by traversing the first hierarchical structure 200 from a root resource 205 to the given resource in order to collect role membership assignments.

An illustrative example of the method, with reference to FIGS. 2 through 4, follows:

Assume a member of the IT-Group attempts to read the city associated with the uid=sue resource 222. To authorize the attempt, an access check will be performed, and the following information will be made available to determine whether access to perform the attempted action shall be provided. As part of the access check, it will be determined that the principal is part of the IT-Group, that the resource 201 that has been attempted to be accessed is/root/o=ibm/ou=tivoli/uid=sue, and that this resource is of type BP-Person. Note that information regarding whether this resource is a Person or BP-Person may be contained in the resource itself. Finally, a request permission, which specifies the requested action, will be developed, and take a form such as: UserPermission(“Person/BP-Person/”,“address/city/”, “READ”). This is what is meant by dynamically creating the permission. The contents of the permission, such as the object type, are not known in advance, and are determined possibly by looking up data contained in the resource.

The attempt will be allowed only if the IT-Group is granted the request permission at Sue's resource location 222 within the first hierarchy structure 200. Given the above information, this will require two steps. First is to determine the role membership for IT-Group at Sue's resource location 222, thereby determining the access permissions. From the grant box 250 depicted in FIG. 2, as discussed above, it will be appreciated that the IT-Group is a member of the Administrator role at Sue's resource location 222. The second step is to compare the request permission to the access permission assigned to the Administrator role.

In a manner similar to the request permission, the access permission utilizes a UserPermission format, the UserPermission format comprising an object, an attribute, and an action in this embodiment. As discussed above, in an embodiment, the resource classification hierarchies 300, 400 can be hierarchical by nature. For example, the business partner person 310 shares common attributes with the person 305, and as a result, the business partner person 301 may be derived from the person 305 entity. The classification hierarchies 300, 400 are distinct and unrelated to the first hierarchy structure, and are used only when comparing two UserPermissions. Because the resource types being protected are hierarchical, the appropriate convention is to define resource types as hierarchical strings, such as “Person/”, “Person/BPPerson/”, and “Group/”, for example.

In an embodiment, it may be desirable to apply permissions to all subordinate classification hierarchy 300, 400 resource types. Therefore the UserPermission format will allow the use of wild cards to define the access permission. During the access check, the request permission representing the principal's attempt to perform an action on a specific resource is dynamically created. The request permission never includes wildcards, because it will always refer to a specific resource of the plurality of resources 201. The request permission is compared against the access permissions to determine if the access request should be granted.

As an example, assume that the Administrator role has been assigned access permissions defined by the following: UserPermission(“Person/*”,“address/*”,“READ”). In the example of attempting to read the city of the uid=sue resource 222, the request permission will have the form UserPermission(“Person/BP-Person/”,“address/city/”, “READ”). The method will compare the access permission to the request permission by performing a wildcard string comparison of the classification hierarchies 300, 400, and an exact string comparison on the action. Accordingly, it will be found that the “Person/BP-Person/” request permission matches the “Person/*” access permission, and a likewise match for the “address/city/” request and “address/*” access. Because the “READ” action is a match between the request and access permissions, the access by a member of the IT-Group to read the city of the uid=sue request is granted.

It will be appreciated that in an embodiment of the invention as disclosed above, protection may be provided to only persons in the Tivoli organization, only BP-Persons in the Tivoli organization, and both Persons and BP-Persons within the Tivoli organization. It will be further appreciated that in an embodiment of the invention as disclosed above, protection may be provided to only the city in the address attribute, and all sub-fields of the address attribute. While an embodiment has been described with two classification hierarchies contained within the access permission, it will be appreciated that there is no limit to the number of hierarchies that may be contained with the UserPermission format of the access permission. The comparison will grant access only if the hierarchies in the request permission are matched to the hierarchies in the access permission.

The capabilities of the present invention can be implemented in software, filmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for controlling access of a principal to a plurality of resources, the method comprising:
organizing each of the plurality of resources within a first hierarchical structure such that they are capable of classification by a set of additional hierarchies unrelated to the first hierarchical structure, thereby providing for the use of multiple hierarchies for controlling access of the principal;
assigning access permissions to each role of a set of roles, each role capable of being associated with the principal;
wherein the assigning access permissions is via one or more of the classification hierarchies and an action that the principal may be allowed to perform relative to the resources, the classification hierarchies associated with contents of the resources and capable of including subordinate classification hierarchies via wildcard operators;
assigning a role of the set of roles to the principal, and associating the role assignment with at least one first resource of the plurality of resources within the first hierarchical structure;
associating a scope with the role assignment, the scope defining a relationship between the at least one first resource and other resources within the first hierarchical structure;
dynamically creating a request permission in response to an attempted action upon a second resource by the principal, the request permission defined by one or more of the classification hierarchies and an action that the principal has attempted to perform;
comparing the request permission to the access permission; and
in response to determining that the access permission allows the request permission, granting access to perform the action.

2. The method of claim 1, wherein:
the assigning access permissions is via at least two of the classification hierarchies; and
the dynamically creating a request permission in response to an attempted action upon a second resource by the principal comprises the request permission defined by at least two of the classification hierarchies and an action that the principal has attempted to perform.

3. The method of claim 1, wherein:
the organizing each of the plurality of resources within the first hierarchical structure such that they are capable of classification by the set of additional hierarchies unrelated to the first hierarchical comprises a set of additional object classification hierarchies.

4. The method of claim 1, wherein:
the organizing each of the plurality of resources within the first hierarchical structure such that they are capable of classification by the set of additional hierarchies unrelated to the first hierarchical structure comprises a set of additional attribute classification hierarchies.

5. The method of claim 1, wherein:
the organizing each of the plurality of resources within a first hierarchical structure comprises organizing each of the plurality of resources within the first hierarchical structure in a manner suitable for administering or applying access control policies.

6. The method of claim 1, wherein:
the comparing comprises a wildcard string comparison on the one or more classification hierarchies and an exact string comparison on the action

7. The method of claim 1, wherein:
the organizing each of the plurality of resources within the first hierarchical structure such that they are capable of classification by the set of additional hierarchies unrelated to the first hierarchical structure comprises the set of additional classification hierarchies unrelated to each other.

8. The method of claim 7, wherein:
the organizing each of the plurality of resources within the first hierarchical structure such that they are capable of classification by the set of additional hierarchies unrelated to the first hierarchical structure comprises the set of two or more additional classification hierarchies unrelated to each other.

9. The method of claim 1, further comprising:
determining the role of the principal at a given resource within the first hierarchical structure, thereby determining the access permissions for the principal.

10. The method of claim 9, wherein the determining the role of the principal at the given resource within the first hierarchical structure comprises:
traversing the first hierarchical structure from a root resource to the given resource in order to collect role membership assignments.

11. A program storage device readable by a machine, the device embodying a program or instructions executable by the machine to perform the method of claim 1.
